(19) United States
(12) Patent Application Publication
(10) Pub. No.: US 2007/0162480 A1
(43) Pub. Date: Jul. 12, 2007

(54) System and method for monitoring consumables in a document processing environment

(75) Inventors: Man Mohan Garg, Cerritos, CA (US); Michael Yeung, Mission Viejo, CA (US); Ajit Sodhi, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/328,538

(22) Filed: Jan. 10, 2006

(51) Int. Cl. G06F 7/00; G06F 17/00

(52) U.S. Cl. 707/101

(57) ABSTRACT

A system and method for monitoring consumables in a document processing environment. A quota corresponding to an allotted quantity of consumables is maintained with respect to each authorized user in a document processing environment. When a document processing request is received, the user associated therewith is identified, authenticated, and the quota associated with the user is retrieved. When the quota associated with the user has already been exceeded, the document processing request is denied. When the quota has not been exceeded, the request is then analyzed to determine image parameters inclusive of size and image number, page number, printing type, scanning parameters, and the like. These image parameters are then used to calculate the amount of consumables necessary to complete the requested document processing operation. When the amount of required consumables exceeds the allotted quota, the operation is denied. When the amount does not exceed the allotted quota, the operation is performed and the quota is updated to reflect the consumable usage.

### BACKGROUND OF THE INVENTION

This invention is directed to a system and method for monitoring of consumables in a document processing environment. In particular, this invention is directed to a system and method for monitoring and enforcing usage of consumables, such as toner usage, in a document processing environment at a higher level of granularity.

Document processing devices, such as multifunctional peripheral devices, allow users to perform a wide array of document processing operations and include many features or options available for such processing operations. For example, the multifunctional peripheral device may include the ability to generate documents containing color or other specialized fonts, generate documents on special paper size, such as A4, or insert tabs or dividers into a document. In a typical document processing environment, a multifunctional peripheral device will be available for use by many users. Therefore, the multifunctional peripheral device will be equipped with accounting features and systems to report different user or department usage information. Such systems typically consist of an accounting database and a set of counters as known in the art associated with each account. Any operation performed on the multifunctional peripheral device, such as copying, printing, or scanning, is charged to the respective user or department.

Multifunctional peripheral devices generally only contain a limited number of counters for tracking usage, such as only counters for tracking the number of pages printed per account and the number of color pages printed per account. As an example, if a user is only allowed to print a specified number of color pages, the counting mechanism on the multifunctional peripheral device will count each page containing any color as a color page towards the allotment provided to that user. The counting mechanism would not be able to distinguish the amount of color required for a color photograph as compared to a word document containing only a few lines of color, even though the amount of color toner consumed in the two operations varies greatly.

In another example, if a user had an allotment of a specified number of pages and user desired to print a document onto a ledger-sized paper as opposed to a letter-sized paper, the counter mechanism would treat a document printed on the ledger paper the same as document printed on a letter paper. However, ledger-sized paper is more expensive and a document printed on ledger-sized paper requires more processing time. As such, there is a need for an improved system and method for monitoring the consumption of consumables in a document processing environment.

The subject invention overcomes the above-noted problems and provides a system and method for monitoring and enforcing usage of consumables in a document processing environment at a higher level of granularity.

### SUMMARY OF THE INVENTION

In accordance with the present invention, there is provided a system and method for monitoring consumables in a document processing environment.

Further, in accordance with the present invention, there is provided a system and method for monitoring and enforcing usage of consumables in a document processing environment at a higher level of granularity.

Further, in accordance with the present invention, there is provided a system and method for monitoring the usage of consumables in a document processing environment which calculates the usage based on document processing operation selected and image parameters specified.

Still further, in accordance with the present invention, there is provided a system for monitoring consumables in a document processing environment. The system comprises means adapted for receiving identification data representative of a user of the associated document device and means adapted for receiving usage data representative of consumption of at least one consumable in an associated document processing device for at least one document processing operation, wherein the usage data corresponds to identification data. The system also comprises accumulator means adapted for accumulating usage data and means adapted for receiving allotment data representative of an allotment of the at least one consumable relative to the user. The system further includes comparison means adapted for comparing accumulated usage data with allotment data and means adapted for generating a signal as a result of a comparison completed by the comparison means.

Still further, in accordance with the present invention, there is provided a method for monitoring consumables in a document processing environment. The method includes the steps of receiving identification data representative of a user of the associated document device and receiving usage data representative of consumption of at least one consumable in an associated document processing device for at least one document processing operation, wherein the usage data corresponds to identification data. The method further accumulates usage data and receives allotment data representative of an allotment of the at least one consumable relative to the user. The method then compares accumulated usage data with allotment data and generates a signal as a result of a comparison completed by the comparison means.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating a method for monitoring the usage of consumables in a document processing environment in accordance with the present invention.

### DETAILED DESCRIPTION OF THE PREFERRED EMBODIMENT

This invention is directed to a system and method for monitoring consumables in a document processing environment. More particularly, this invention is directed to a system and method for monitoring the usage of consumables in a document processing environment which calculates the usage based on document processing operation selected and image parameters specified. In the preferred embodiment of the present invention, the document processing environment is a document processing device. More preferably, the document processing device is an image generating device, such as a multifunctional peripheral device, capable of providing copying, printing, electronic mail, scanning, facsimile, document storage, document management, and other functions to a user.

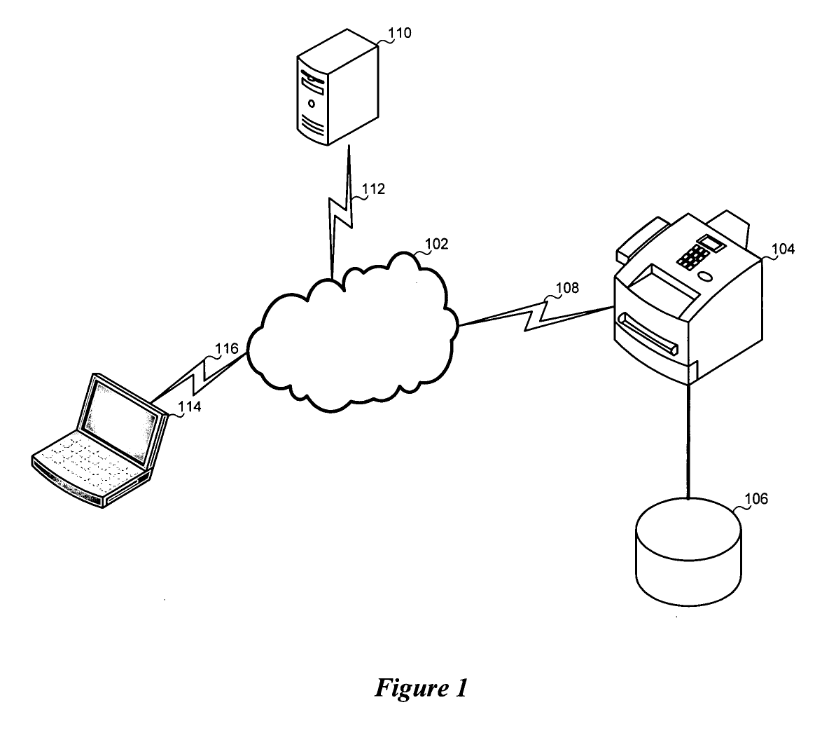

Referring now to FIG. 1, there is shown a block diagram illustrating a system 100 in accordance with the present invention. It will be appreciated by those skilled in the art that the system 100 is for example purposes only and the instant invention is adaptable to a variety of implementations. As shown in FIG. 1, the system 100 includes a distributed computing environment, illustrated in FIG. 1 as a computer network 102. It will be appreciated by those skilled in the art that the instant invention is not limited to application over the computer network 102, but is suitably capable of implementation outside a network, such as via a standalone document processing device. Those skilled in the art will appreciate that the computer network is any distributed computing environment known in the art including, for example and without limitation, a personal area network, a local area network, a wide area network, the Internet, an intranet, or any combination thereof.

The system 100 also includes at least one document processing device 104, illustrated in FIG. 1 as a multifunction peripheral device, advantageously coupled to the computer network 102 via a suitable communications link 108. It will be understood by those skilled in the art that the representation of the document processing device 104 as a multifunction peripheral device is to illustrate the ability of the document processing device 104 to provide a plurality of document processing services, such as, for example and without limitation, printing, facsimile, copying, scanning, and the like. Suitably commercially available document processing devices include, but are not limited to, the Toshiba e-Studio Series Controller. Preferably, the communications link 108 is any communications channel, known in the art, and capable of enabling the two-way exchange of data, including, audio, video, image, text, and any combination thereof. Suitable communications channels include, for example and without limitation, wired or wireless data communications channels known in the art, such as Bluetooth, WiMax, 802.11a, 802.11b, 802.11g, 802.11(x), infrared, optical, and the like. In accordance with one aspect of the present invention, the document processing device 104 is advantageously equipped to receive a variety of portable storage media, so as to access the data contained thereon. Such portable storage media includes, but is not limited to, Firewire drives, USB drives, SD, MMC, XD, Compact Flash, optical storage media, magnetic storage media, and the like. In another aspect of the present invention, the document processing device 104 further includes an associated user-interface, such as a touch-screen display, alphanumeric keypad, function specific keys, mouse, LCD, or any combination thereof.

The document processing device 104 of the system 100 further includes an associated storage device 106, communicatively coupled thereto. It will be apparent to those skilled in the art that the associated storage device 106 is suitably any mass storage device known in the art. Suitable devices include, for example and without limitation, hard disk drives, optical storage drives, magnetic drives, remote storage sites, or any combination thereof. In accordance with one aspect of the present invention, the associated storage device 106 is advantageously in data communication with a plurality of document processing devices, which belong to a document processing system, such that data stored on the associated storage device 106 is equally accessible to each document processing device connected to the processing system. More preferably, the associated storage device 106 advantageously stores a plurality of user information, including quotas, limits, costs, usage rights, and the like, associated with each user of the document processing device 104.

The system 100 further includes an authentication server 110, communicatively coupled to the network 102 via a suitable communications link 112. In accordance with one aspect of the present invention, the authentication server 110 is any hardware, software, or combination thereof suitably adapted to verify a user based on received user information. Preferably, the authentication server 110 receives user identification data from the document processing device 104 and determines whether the user, as recognized by the user information, is authorized to make use of the document processing services performed by the document processing device. Although illustrated in FIG. 1 as a separate and distinct component of the system 100, it will be understood by those skilled in the art that the authentication server 110 is capable of being implemented as integral with the document processing device 104, such that the two components share the same physical hardware. Furthermore, the skilled artisan will appreciate that while shown as being coupled to the document processing device 104, the associated data storage device 106 is equally capable of being connected to or forming a portion of the authentication server 110 such that other document processing devices have access thereto.

The system 100 of FIG. 1 further includes at least one client device 114, illustrated as a laptop computer. It will be appreciated by those skilled in the art that the present invention is not limited to a single client device, but rather is capable of allowing any number of client devices, to be used in accordance with the present invention. As will be understood by those skilled in the art, the communications link 116 is representative of a plurality of communications channels which the client device 114 is capable of using to exchange data with the network 102. Thus, for example and without limitation, the communications link 116 is any wired or wireless data communications channel known in the art, such as Bluetooth, WiMax, 802.11a, 802.11b, 802.11g, 802.11(x), infrared, optical, and the like. It will also be appreciated by those skilled in the art that the client device 114 is suitably any personal electronic device known in the art capable of interfacing with the computer network 102 and the document processing device 104. Suitable client devices include, for example and without limitation, a smart phone, a personal data assistant, a desktop computer, a web-enabled cellular communications device, and the like.

In operation, the system 100 of the present invention enables the accurate and efficient management of consumable quotas with respect to a user and an associated document processing device 104. Thus, a user, associated with the client device 114, submits a document processing request to the document processing device 104 via any suitable means. Preferably, the client device 114 transmits the document processing request to the document processing device 104 over the computer network 102. It will be understood by those skilled in the art that the user is capable of interacting directly with the document processing device 104, thereby bypassing use of the client device 114. For example, a document processing request is advantageously stored on a portable media, which is accessed by the user at the user-interface associated with the document processing device 104.

Once the request has been received, the user is required to provide authentication information so as to enable the document processing device 104 to determine the quotas, usage rights, and authorization of the user with respect to requesting document processing operations. Suitable authentication information includes, but is not limited to, biometrics, user-name, password, or any combination thereof. The authentication information is then compared against user information stored in the authentication server 110, so as to verify the identity of the user and retrieve user data, including, without limitation, access rights, usage rights, quotas, and the like. It will be appreciated by those skilled in the art that the term quota, as used herein, is suitably representative of a quantity of consumables which the user is allowed to consume. For example, a user is capable of being limited to X number of pages, X quantity of black toner, X number of inserts, and the like. Consumables include, for example and without limitation, black toner, color toner, black ink, color ink, normal paper, special paper, device usage time, inserts, tabs, scanner usage, facsimile line incoming/outgoing, storage size, or any combination thereof.

Those skilled in the art will appreciate that the authentication and retrieval of user information is capable of being performed by the document processing device 104, wherein the device 104 functions include authentication functions. In such an implementation, the user information is advantageously stored in the associated storage device 106. Thus, the access rights, usage rights, quotas, and the like, are locally stored with respect to the document processing device 104. Once the document processing device 104 has retrieved the quota allowed to the user for each consumable, the document processing device 104 then determines whether the identified user is already over the quota allotted to that particular user. When such an event occurs, the document processing device 104 informs the user via any suitable means of the over quota situation. The user is then able to contact a system administrator to increase the allotted quota, or in one particular embodiment, submit payment for additional consumables.

When the user is not initially over the allotted quota, the document processing device 104 analyzes the images of the document processing request on a page by page basis, and calculates the size and number of images based on image placement and the number of copies. That is, the document processing device 104 analyzes the document processing request to determine the number of pages and size of the file being processed. The document processing device 104 then calculates the actual consumption of each controlled consumable on the basis of image parameters, size and number of images along with other job parameters, such as for example and without limitation, duplex uses single sheets of paper to output two pages, however it requires additional processing time. It will be appreciated by those skilled in the art that the consumables include the fine grain control of, for example and without limitation, black toner, color toner, normal paper (consumption dependent upon size), special paper (separate quote for each type of paper), device processing time (longer for specialized document processing requests, inserts, tabs, scanner usage, facsimile line incoming/outgoing, storage, and the like.

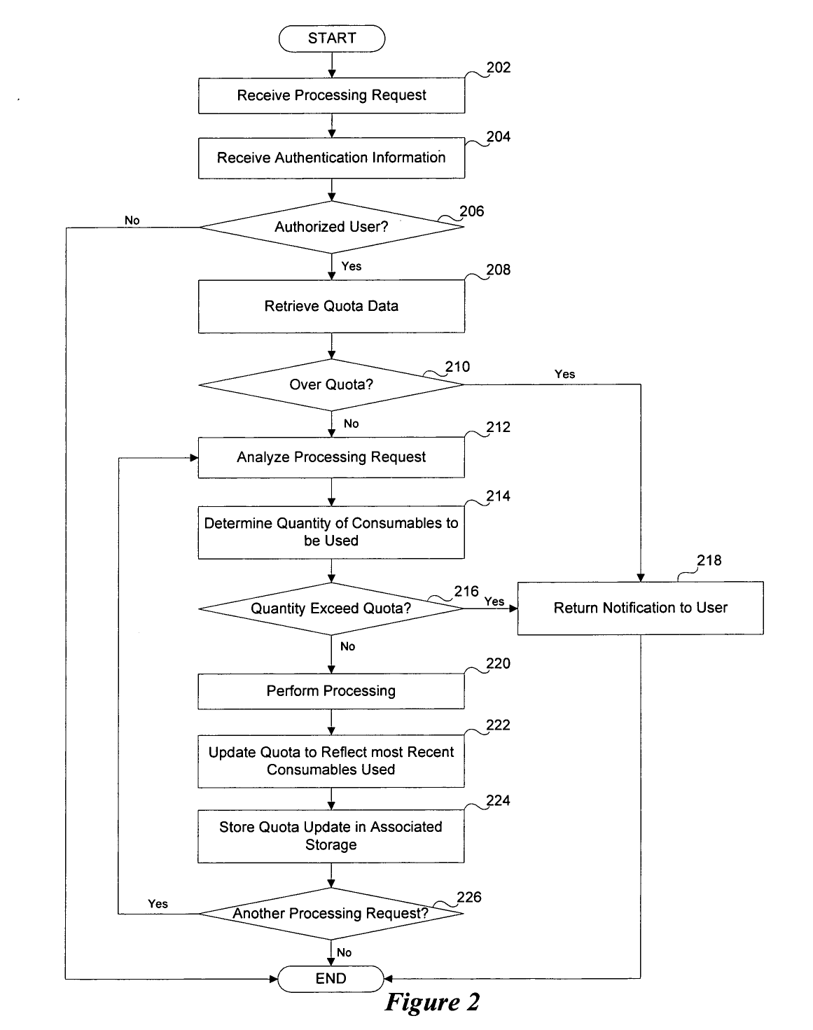

The calculated quantity of consumables that will be consumed is then compared against the retrieved quota allotment to determine whether the submitted document processing request will exceed the allotted quota. When processing of the request exceeds the allotted consumables, the user is notified via any suitable means, thereby allowing the user to cancel the request, contact a system administrator to increase the user's quota, or purchase additional consumables. When processing of the request does not exceed the user's quota of consumables, the document processing device 104 performs the requested document processing operation. Upon completion of the document processing operation associated with the document processing request, the document processing device 104 updates the user's quota to reflect the amount of consumables used. The updated quota information is then stored, either in the associated storage device 106, or alternatively, in the centralized authentication server 110. The foregoing system 100 will better be understood when viewed in accordance with the method detailed in the flowchart 200 of FIG. 2, discussed hereinafter.

Referring now to FIG. 2, there is shown a flowchart 200 illustrating a method for monitoring consumables in a document processing environment. The method begins at step 202, whereupon the document processing device 104 receives a document processing request. The processing request is suitably received from a client device 114, portable storage device, associated storage device 106, or the like. Upon receipt of the processing request, flow proceeds to step 204, wherein the document processing device receives authentication information. Preferably, the authentication information includes data representative of the identity of the user, such as, for example and without limitation, a user-name/password combination, or the like.

The authentication information is then compared to user authentication information and a determination is made at step 206 whether the user is authorized. It will be understood by those skilled in the art that the determination is advantageously made by the authentication server 110. Preferably, the document processing device 104 transmits the received authentication information over the computer network 102 to the authentication server 110, which thereon performs the authentication of the user submitting the document processing request. In one particular embodiment, the authentication server 110 further includes data representative of a quota of allotted consumables associated with the user corresponding to document processing operations. In another embodiment, the user authentication information and quota data is advantageously stored in the associated storage device 106, whereupon the document processing device 104 performs the authentication and retrieval steps.

When the user submitting the document processing request is not authorized to make use of the document processing services offered by the document processing device 104, the method of FIG. 2 terminates. Following authentication and authorization at step 206, flow proceeds to step 208, whereupon quota data is retrieved. As explained above, the instant invention is suitably capable of employing the remote authentication server 110 for quota storage, as well as the associated storage device 106. Irrespective of where the quota data is stored, the document processing device 104 determines, at step 210, whether the user has already exceeded the allotted usage of consumables. That is, the document processing device 104, upon receipt of the quota data, determines whether or not the quota has already been exceeded by the user. When the user is over quota, flow proceeds to step 218, whereupon the user is notified, via any suitable means, of the over-quota status associated therewith. The skilled artisan will appreciate that in accordance with one aspect of the present invention, a user is capable of purchasing additional consumable usage via a printing system, securing additional usage via a system administrator, or the like.

When the user is determined not to have exceeded the quota allotted thereto, flow proceeds to step 212, at which time the document processing device 104 analyzes the document processing request to determine image parameters associated with the document processing request. These image parameters include, for example and without limitation, a page-by-page determination of the size and number of images present thereon, the number of output copies selected by the user, type of output, and the like. The document processing device 104 then calculates, at step 214, the quantity of consumables that will be used in completing the document processing operation. In accordance with the present invention, the document processing device 104 accurately determines, from the image parameters, the amount of, for example, toner, needed to output each page of the document. Such processing ignores those areas of the page that have no toner, i.e., no image located thereon, which enables the accurate determination of the actual amount of toner placed on a page, instead of basing the quota on the number of pages. It will be appreciated by those skilled in the art that accurate determination of consumable quantities is capable of being accomplished by the document processing device via a variety of methods, including, for example and without limitation, the partial rendering of each page to determine image placement, the calculation of color toners used in the output, and the like.

Following a determination of the quantity of consumables to be used to process the document processing request, a determination is made at step 216 whether the request will exceed the pre-established quota of allotted consumables. For example, while the user has not previously exceeded the quota, the entire document processing request cannot be completed without the user exceeding the quota of allotted consumables. When the processing of the request will result in the user exceeding the quota, flow proceeds to step 218, whereupon the user is notified, via a message to the client device 114, a display on the associated user-interface, or other suitable means known in the art, of the issues involved in completing the document processing request. The user is then able to secure additional consumables as discussed above, or wait until such time as the user has sufficient quota to enable processing of the document processing request.

When it is determined that completion of the document processing request will not exceed the user's quota of consumables, flow proceeds to step 220, whereupon the document processing device 104 performs the requested document processing operation. Upon completion of the document processing operations associated with the document processing request, the user's quota information is updated to reflect the most recent usage of consumables at step 222. The updated quota data is then stored in associated storage 106 at step 224. In accordance with one aspect of the present invention, the updated quota information is stored in association with the user identification data resident on the authentication server 110. It will be appreciated by those skilled in the art that such storage on the server 110 enables the user to access additional document processing devices in data communication with the server 110, and not be limited to only access the document processing device 104 illustrated in FIG. 1. Following updating of the quota information, a determination is made at step 226 whether the user has submitted an additional document processing request. When no additional requests have been received corresponding to the user, the session terminates and the document processing device 104 awaits receipt of the next request. When additional requests have been received from the same user, flow returns to step 212, whereupon the request is analyzed to determine image parameters and the like. Operations on the next request continue as explained in detail above.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

While in the preferred embodiment the present invention is implemented in software, as those skilled in the art can readily appreciate it may also be implemented in hardware or a combination of software and hardware. Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed:

1. A system for monitoring consumables in a document processing environment comprising:
means adapted for receiving identification data representative of a user of the associated document device;
means adapted for receiving usage data representative of consumption of at least one consumable in an associated document processing device for at least one document processing operation, wherein the usage data corresponds to identification data;
accumulator means adapted for accumulating usage data;
means adapted for receiving allotment data representative of an allotment of the at least one consumable relative to the user;
comparison means adapted for comparing accumulated usage data with allotment data; and
means adapted for generating a signal as a result of a comparison completed by the comparison means.

2. The system for monitoring consumables in a document processing environment of claim 1 wherein the means adapted for generating signal generate a signal enabling operation of the associated document processing device relative to the user for the at least one document processing operation.

3. The system for monitoring consumables in a document processing environment of claim 2 further comprising means adapted for updating accumulated usage data after completion of the at least one document processing operation.

4. The system for monitoring consumables in a document processing environment of claim 3 further comprising means adapted for generating cost data representative of cost associated with usage of the at least one consumable relative to the user for the at least one document processing operation.

5. The system for monitoring consumables in a document processing environment of claim 1 wherein the means adapted for generating a signal further comprise means adapted for generating disable signal adapted for disabling operation of the associated document device relative to the user for the at least one document processing operation when a pre-selected usage threshold is exceeded as indicated by the comparison means.

6. The system for monitoring consumables in a document processing environment of claim 5 further comprising reset means for generating a reset signal adapted to selectively re-enable the associated document processing device.

7. The system for monitoring consumables in a document processing environment of claim 6 wherein the reset signal is generated at pre-selected time intervals.

8. The system for monitoring consumables in a document processing environment of claim 6 wherein the reset signal is generated in accordance with a override signal, which override signal is generated in accordance with at least one of an administrative override, allotment increase, and secondary allotment data.

9. The system for monitoring consumables in a document processing environment of claim 1 wherein the usage data for the consumption of at least one consumable includes toner usage, number of pages processed, number of tab pages processed, document processing time, data storage, and data transmission time.

10. A method for monitoring consumables in a document processing environment comprising the steps of:
receiving identification data representative of a user of the associated document device;
receiving usage data representative of consumption of at least one consumable in an associated document processing device for at least one document processing operation, wherein the usage data corresponds to identification data;
accumulating usage data;
receiving allotment data representative of an allotment of the at least one consumable relative to the user;
comparing accumulated usage data with allotment data; and
generating a signal as a result of a comparison completed by the comparison means.

11. The method for monitoring consumables in a document processing environment of claim 10 wherein the step of generating signal generates a signal enabling operation of the associated document processing device relative to the user for the at least one document processing operation.

12. The method for monitoring consumables in a document processing environment of claim 11 further comprising the step of updating accumulated usage data after completion of the at least one document processing operation.

13. The method for monitoring consumables in a document processing environment of claim 12 further comprising the step of generating cost data representative of cost associated with usage of the at least one consumable relative to the user for the at least one document processing operation.

14. The method for monitoring consumables in a document processing environment of claim 10 wherein step of generating a signal generates a disable signal adapted for disabling operation of the associated document device relative to the user for the at least one document processing operation when a pre-selected usage threshold is exceeded as indicated by the comparison means.

15. The method for monitoring consumables in a document processing environment of claim 14 further comprising the step of generating a reset signal adapted to selectively re-enable the associated document processing device.

16. The method for monitoring consumables in a document processing environment of claim 15 wherein the reset signal is generated at pre-selected time intervals.

17. The method for monitoring consumables in a document processing environment of claim 15 wherein the reset signal is generated in accordance with a override signal, which override signal is generated in accordance with at least one of an administrative override, allotment increase, and secondary allotment data.

18. The method for monitoring consumables in a document processing environment of claim 10 wherein the usage data for the consumption of at least one consumable includes toner usage, number of pages processed, number of tab pages processed, document processing time, data storage, and data transmission time.

19. A computer-implemented method for monitoring consumables in a document processing environment comprising the steps of:
receiving identification data representative of a user of the associated document device;
receiving usage data representative of consumption of at least one consumable in an associated document processing device for at least one document processing operation, wherein the usage data corresponds to identification data;
accumulating usage data;
receiving allotment data representative of an allotment of the at least one consumable relative to the user;
comparing accumulated usage data with allotment data; and
generating a signal as a result of a comparison completed by the comparison means.

20. The computer-implemented method for monitoring consumables in a document processing environment of claim 19 wherein step of generating a signal generates a disable signal adapted for disabling operation of the associated document device relative to the user for the at least one document processing operation when a pre-selected usage threshold is exceeded as indicated by the comparison means.

21. The computer-implemented method for monitoring consumables in a document processing environment of claim 20 further comprising the step of generating a reset signal adapted to selectively re-enable the associated document processing device.

22. The computer-implemented method for monitoring consumables in a document processing environment of claim 21 wherein the reset signal is generated at pre-selected time intervals.

23. The computer-implemented method for monitoring consumables in a document processing environment of claim 21 wherein the reset signal is generated in accordance with a override signal, which override signal is generated in accordance with at least one of an administrative override, allotment increase, and secondary allotment data.
